(19) United States
(12) Patent Application Publication
(10) Pub. No.: US 2018/0119293 A1
(43) Pub. Date: May 3, 2018

(54) Salt cycle for hydrogen production

(71) Applicant: Tolulope Israel Mayomi, Johnstown, PA (US)

(72) Inventor: Tolulope Israel Mayomi, Johnstown, PA (US)

(73) Assignee: Tolulope Israel Mayomi, Prince George's County, MD (US)

(21) Appl. No.: 15/338,389

(22) Filed: Oct. 30, 2016

(51) Int. Cl. C25B 1/02; C25B 15/02; C01B 17/16

(52) U.S. Cl. CPC C25B 1/02; C01B 17/162; C25B 15/02

(57) ABSTRACT

This present invention relates to a process that can be used to create electricity, hydrogen and sulfuric acid by combining a thermodynamic cycle with electrochemical and chemical reactions

### FIELD OF THE INVENTION

The present invention relates to a method for producing hydrogen, sulfuric acid and electricity through chemical reactions, electrolysis and thermodynamic cycles.

### BACKGROUND OF THE INVENTION

The present invention is in the technical field of engineering. More particularly, the present invention is in the field of thermodynamics, material science, electrochemistry.

Current processes used to generate hydrogen such as steam methane reforming or electrolysis are either expensive or they produce a lot of greenhouse emissions. Hence, there is a need for an inexpensive and environmentally friendly process of generating hydrogen that can be scaled up commercially.

### SUMMARY OF THE INVENTION

The present invention is a process that can be used to produce electricity, sulfuric acid and as well as hydrogen.

This new process of generating electricity, hydrogen, and sulfuric acid involves the use of a thermodynamic cycle in addition to a few side reactions to produce the products mentioned above.

### BRIEF DESCRIPTION OF DRAWINGS

FIG. 1 is a flow chart of the process used for Hydrogen, electricity and sulfuric acid production

FIG. 2 is a flow chart of an alternative process used to produce the same products in FIG. 1.

FIG. 3 shows the thermodynamic cycle used for producing electricity to power the electrolyzer.

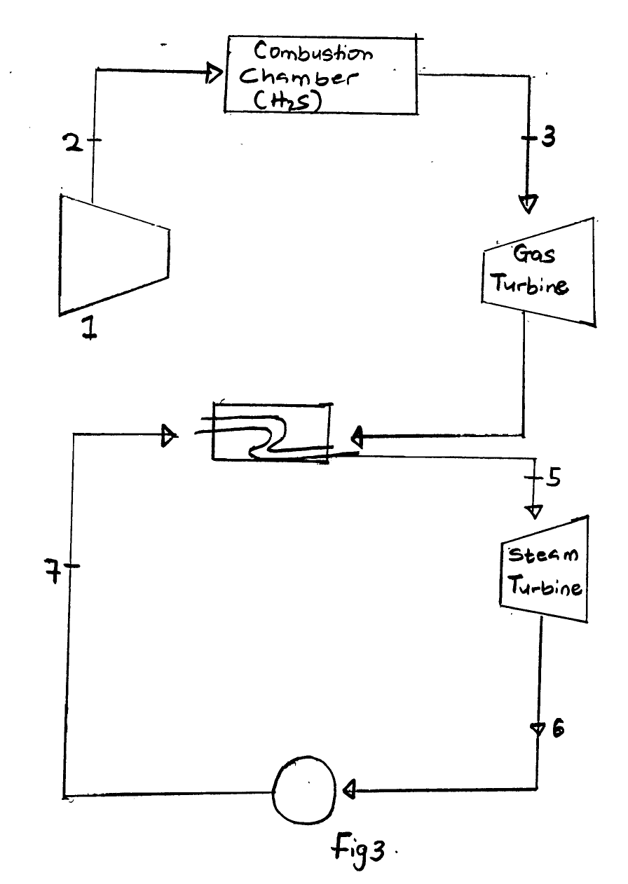

### DETAILED DESCRIPTION OF THE INVENTION

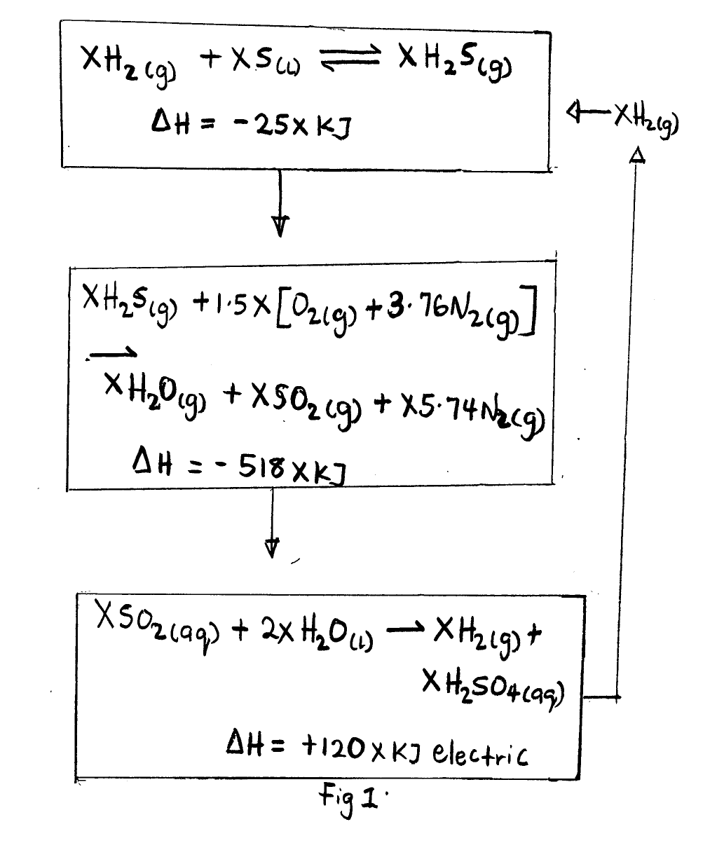

As shown in FIG. 1, the Salt Cycle for Hydrogen Production comprises of several steps that occur to produce electricity, hydrogen and sulfuric acid.

In the thermodynamic part, there is the production of electricity in a gas turbine as well as a steam turbine. The fuel used in the gas turbine is hydrogen sulfide while steam provides the energy for the steam turbine.

Overall, the reaction that occurs in the combustor of the gas turbine can be shown as

xH₂S+1.5x[O₂+3.76N₂]→xSO₂+xH₂O+5.74xN₂

ΔH=−517x KJ

The products of this reaction (SO₂ and H₂O) are very hot. They are therefore sent to a heat exchanger known as a heat recovery steam generator to produce steam. It is this steam that is then used in a steam turbine to produce electricity.

Once the products of the reaction shown above leave the heat exchanger used to produce steam, they can be put into other heat exchangers to provide the heat required for the electrolyzer used in the electrochemical cycle. Overall, the electrolyzers work most efficiently at about 70100 degrees Celsius.

After the products of the reaction shown above leave the heat exchangers used for the electrolyzers, they are then mixed with water with the result being that SO₂ (g) dissolves in water while Nitrogen is left out. H₂O (g) produced also mixes with the water as it becomes liquid at this stage.

SO₂ (g) dissolves in water with the production of about 11 KJ of heat. The Nitrogen gas that is undissolved is sent out into the atmosphere.

The overall effect of the thermodynamic part of the whole cycle is to produce electricity. A part of this electricity will be used in the electrochemical reaction. Another effect is to produce SO₂ (g), which will be used in the electrochemical reaction cycle as well as H₂O which will be used in the electrochemical reaction.

Once the SO₂ (g) is mixed with water, it can be used in the electrochemical reaction. There are two ways to do this. The first is that either the SO₂ (g) dissolved in the water to become SO₂(aq) is sent to the electrochemical part of the cycle or the SO₂(g) is removed from the water by the application of heat. This can be done by using the waste heat in the thermodynamic cycle to heat up the water containing dissolved SO₂(g) to release the SO₂(g). The amount of heat needed by the Chatliers principle is about 11.6 KJ.

The hardware for the electrochemical reaction consists primarily of the electrolyzer and all other supporting elements. The electrolyzer used in this cycle is referred to as a Sulfur dioxide depolarized electrolyzer abbreviated as SDE.

In the SDE, Sulfur dioxide acts to depolarize the anode of the electrolyzer. The results in a significant decrease in the reversible cell potential (and, therefore, the electric power requirement) for the overall reaction. The standard cell potential for the reaction is −0.158 V at 298.15 K, compared to −1.229 V for the electrolysis of water (with oxygen evolution as the anodic reaction).

The SDE typically does not operate at high conversion because the cell potential depends on the concentration of SO₂ at the anode. The SDE is operated with about 40% SO₂ utilization, requiring a large recycle stream and a significant SO₂ concentration in the anolyte effluent. Which means unreacted SO₂ needs to be removed and recycled.

Overall the electrochemical reaction that occurs is shown below

xSO₂(g)+x2H₂O(L)→xH₂(g)+xH₂SO₄(aq)

ΔH=120x KJ (electrical energy)

The H2SO4 produced from this part of the reaction is about 50 WT % for further concentration, excess heat from the thermodynamic part of the reaction might be used.

The overall effect of the electrochemical reaction is to produce hydrogen and sulfuric acid using electricity from the thermodynamic cycle.

The next step involves the reactions that occur to produce the fuel (hydrogen sulfide) used in the thermodynamic cycle to produce electricity.

Hydrogen Sulfide can be produced by reacting hydrogen and sulfur. Therefore, hydrogen obtained from the electrochemical reaction reacts with sulfur as shown in FIG. 1 to produce the hydrogen sulfide used in the thermodynamic cycle. The sulfur is usually in the liquid form.

xH₂(g)+xS(L)→xH₂S(g)

ΔH=−21x KJ

The reaction occurs favorably at about 300-450° C. In the presence of catalysts such as red phosphorus or ultraviolet light.

Hence, the three main reactions that occur in the Salt Cycle for Hydrogen, electricity and sulfuric acid production are shown below.

xH₂S(g)+x1.5[O₂(g)+3.76N₂(g)]→xH₂(g)+xSO₂(g)+x5.74N₂(g)

ΔH=−518x KJ

xSO₂(aq)+x2H₂O(L)→xH₂(g)+xH₂SO₄(aq)

ΔH=+120x KJ→xH₂(g)+xS(L)→xH₂S(g)

ΔH=−25x KJ

The net effect of the steps listed above is to produce electricity and sulfuric acid. The hydrogen that is produced through the above steps is immediately used to create fuel for the thermodynamic cycle.

xH₂S(g)+x1.5[O₂+3.76N₂(g)]→xH₂(g)+xSO₂(g)+x5.74N₂(g)

ΔH=−518x KJ

xSO₂(aq)+x2H₂O(L)→x2H₂(g)+xH₂SO₄(aq)

An alternative method of producing hydrogen, sulfuric acid and electricity through a thermodynamic cycle, electrochemical reactions and chemical reactions are shown below.

x0.39H₂S(g)+x0.585[O₂(g)+x3.76N₂(g)]→x0.39SO₂(g)+x2.20N₂(g)+x0.39H₂(g)

ΔH=−200 KJ

x0.61H₂S(g)+x0.585[O₂(g)+3.76N₂(g)]→x0.61SO₂(g)+x2.20N₂(g)+x0.61H₂O(L)

ΔH=−317x KJ

xSO₂(g)+x2H₂O(L)→xH₂(g)+xH₂SO₄(L)

ΔH=−317x KJ xH₂(g)+

xS(L)→xH₂S(g)

ΔH=−21x KJ

xH₂SO4→xH₂O(L)+xSO₂(g)+x½O₂ (g)

ΔH=+371x KJ

x2H₂O(L)+xSO₂(g)→xH₂(g)+xH₂SO₄(L)

ΔH=+120x KJ

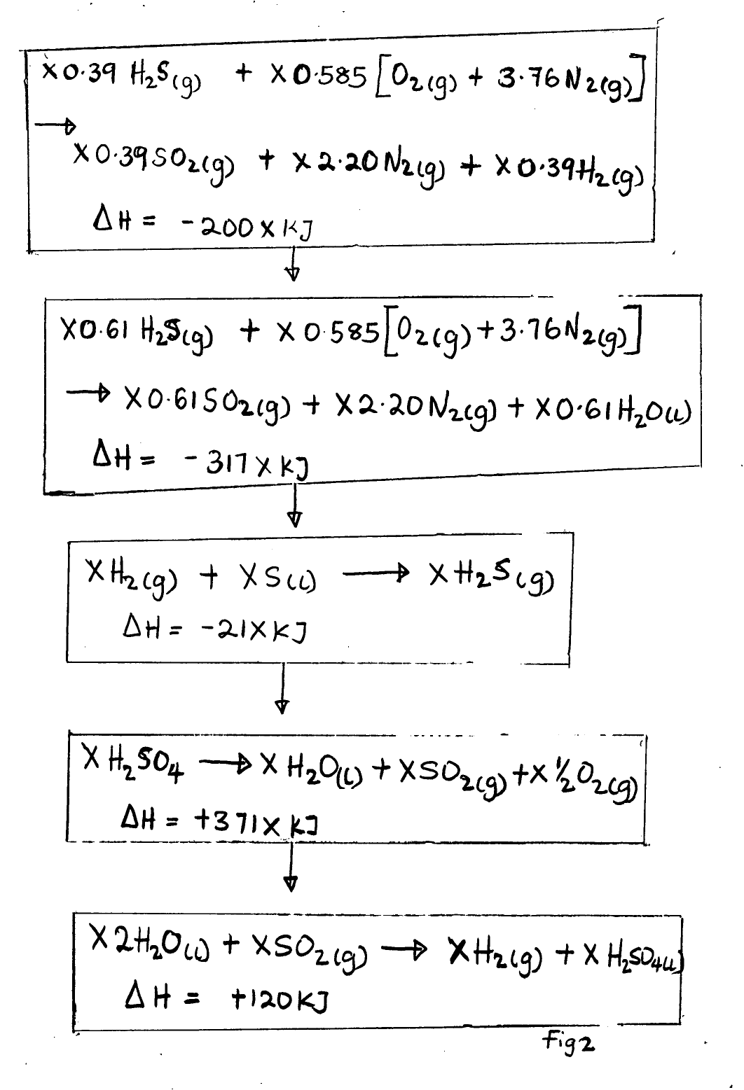

A major difference between this method above (FIG. 2) and the method listed before (FIG. 1) is that in this process (FIG. 2), hydrogen and sulfuric acid are the net products unlike electricity and sulfuric acid in step 1

Another difference is that there are two electrochemical reactions involved in this process. The first electrochemical reaction in this process (FIG. 2) is used to produce hydrogen that is in turn used to create the fuel (hydrogen sulfide) for the thermodynamic reaction and sulfuric acid that is decomposed into sulfur dioxide, water vapor and oxygen. The second electrochemical reaction on the other hand is used to create hydrogen and sulfuric acid that do not have to be reused in the process.

The decomposition of sulfuric acid in FIG. 2 takes place in a reactor at about 1000 degrees Celsius with the heat for this reaction coming from the combustion of hydrogen sulfide gas.

The combustion of hydrogen sulfide gas in FIG. 2 is used in the thermodynamic cycle and as a source of heat for the decomposition of sulfuric acid. The heat produced from this reaction may be carried away by fluids in heat exchangers or by conduction where the combustion reactor where the reaction takes place is in contact with the reactor for the decomposition of sulfuric acid.

1. A process for the creation of electricity, hydrogen and sulfuric acid simultaneously that consists of a thermodynamic cycle, an electrochemical reaction and other side reactions. The process is achieved by the following steps:
Introducing hydrogen sulfide gas into a combustor to act as a fuel in a combined power cycle.
Using the products of the combustion of hydrogen sulfide (Sulfur dioxide, Nitrogen and water vapor) to create steam as part of the combined power cycle
Using the remaining heat available in the products of hydrogen sulfide combustion that are not captured from the heat recovery steam generator in the combined power cycle to generate heat for the Sulfur dioxide depolarized electrolyzer.
Separating the products of hydrogen sulfide combustion by their differences in solubility in water.
Releasing the unwanted nitrogen gas that was separated from other gases in the step above to the atmosphere
Sending the dissolved gases into the sulfur dioxide depolarized electrolyzer.
Using the electricity created from the combined power cycle to power the electrolyzer Obtaining hydrogen and sulfuric acid from the electrolyzer
Sending all the hydrogen obtained from the electrolyzer to a separate reactor to create hydrogen sulfide
Reacting hydrogen and sulfur in a reactor to create hydrogen sulfide.

2. A process for creating hydrogen, electricity and sulfuric acid that utilizes the following method:
Utilizing hydrogen sulfide as fuel to produce electricity in a combined power cycle with sulfur dioxide gas, water vapor and nitrogen as the products of
the combustion of hydrogen sulfide.
Combusting hydrogen sulfide gas to produce heat, sulfur dioxide gas, water vapor and nitrogen, where the heat will be used to concentrate and decompose sulfuric acid into sulfur dioxide, water vapor and oxygen.
Mixing then separating the sulfur dioxide, water vapor, and nitrogen produced from the previous two steps above due to their differences in solubility in water, with nitrogen sent out as undissolved gas while the sulfur dioxide gas dissolves in water.
After separating the gases, using the dissolved gas in a sulfur dioxide depolarized electrolyzer to produce hydrogen and sulfuric acid with the power for the electrolyzer coming from the electricity generated in the combined power cycle.
Reacting the hydrogen produced in the sulfur dioxide depolarized electrolyzer with sulfur to produce the hydrogen sulfide required for step 1.
Sending the sulfuric acid produced in the sulfur dioxide depolarized electrolyzer in step 4 to be concentrated and decomposed in step 2.
Using the products of the decomposition of sulfuric acid in step 2 along with some extra moles of water to produce hydrogen and sulfuric acid in a sulfur dioxide depolarized electrolyzer where the power for the electrolyzer does not come from the combined power cycle.

3. Combining Process 1 and 2 so that the net electricity generated in process 1 is used to generate hydrogen in process 2.
